(19) United States
(12) Patent Application Publication
(10) Pub. No.: US 2008/0271583 A1
(43) Pub. Date: Nov. 6, 2008

(54) FENCE FOR A TABLE SAW

(76) Inventor: Bor-Yann Chuang, Taiping City (TW)

Correspondence Address: SINORICA, LLC, 528 FALLSGROVE DRIVE, ROCKVILLE, MD, 20850, US

(21) Appl. No.: 11/744,265

(22) Filed: May 4, 2007

(51) Int. Cl. B23D 45/06

(52) U.S. Cl. 83/438

(57) ABSTRACT

A fence for a table saw is installed on two rails of the table saw, and includes a retention device pivotally connected to its one end. The retention device is composed of two fixing plates, a cam, a handle, a reinforcing plate and a pressing plate. The cam has an attracting surface with two magnetic elements affixed thereon, and the reinforcing plate is installed inclinedly between the fixing plates. The handle is pushed up or down to let the cam pivoted up and down to force the magnetic elements attracting or leaving the reinforcing plate so that the fence may be released or secured at a selected position on the rails, possible to be adjusted in its position on the rails for conveniently operating the table saw.

### BACKGROUND OF THE INVENTION

1. Field of the Invention

This invention relates to a table saw, particularly to one provided with a retention device for releasing or securing the position of the fence at a selected location on the table and rails of the table saw after adjusted its position on the table and the rails, so the table saw can be operated conveniently.

2. Description of the Prior Art

FIG. 1 shows a US patent titled “Fences For Table Saws” of No. 2005/0139056, which includes a fence 10, two rails 11 for supporting the two ends of the fence 10 respectively, and a retention mechanism 20 installed at one end of the fence 10. The retention mechanism 20 is composed of two fixing plates 21, a cam 22, a handle 23, a magnetic 24 and a pressing plate 25.

The two fixing plates 21 are fixed at the left side and the right side of one end of the fence 10 with a fixing shaft 211 passing through the intermediate portion of the fixing plates 21. The cam 22 is pivotally connected to the bottom of the fixing plates 21, and the handle 23 is fixedly connected to one side of the fixing plates 21. The magnet 24 is affixed on the side of the cam 22 facing the fixing plates 21, and the pressing plate 25 is pivotally connected to the fixing shaft 211, having a pressing surface 251 on the other side. Further, a restricting shaft 212 is pivotally connected to the fixing plates 21 at a point a little lower than the fixing shaft 211, so when the handle 23 is pivoted up to let the magnet 24 attract the restricting shaft 212, with the pressing plate 25 not pressed by the cam 22 and leaving the rail 11 so that the fence 10 may slide freely for adjusting its position on the table and the rails 11.

On the contrary, when the handle 23 is pivoted down, the cam 22 presses the pressing plate 25 tightly on the rails 11 so that the fence 10 may be secured immovable for a work piece. By the way, when the handle 23 is pivoted up, the magnet 24 can be attracted to the restricting shaft 212. But the restricting shaft 212 has a very small radius, its contacting area is very small for attracting the magnet 24, impossible to secure stably the handle 23. Moreover, after a period of using the handle 23 and the cam 22 become loose at its position, the magnet 24 cannot be attracted to the precise location of the restricting shaft 212. Thus the bad stabilization by the mutual attraction of the both components in addition to the excessively large angle of the handle 23 pivoted up may cause difficulty in pivoting down the handle 23. Thus the handle 23 is not convenient to use.

### SUMMARY OF THE INVENTION

A fence for a table saw in the present invention is installed on two slide rails of a table saw, which also includes a base. The fence includes a retention device, which is pivotally connected to one end of the fence and composed of two fixing plates, a cam, a handle, a reinforcing plate, and a pressing plate. The cam has an attracting surface with two magnetic elements fixed thereon, and the reinforcing plate is fixed inclinedly between the two fixing plates, and the cam is possible to be pivoted up and down by the handle. When the cam is pivoted up or down by the handle, the fence can be released or secured at a selected position relative to the table and the rails through the attracting function of the magnetic elements and the reinforcing plate, so the position of the fence on the rails may be moved for adjusting and secured stably thereon. In addition, the reinforcing plate is fixed in an inclining angle between the two fixing plates, strengthening the fixing plates, with the large contacting area of the reinforcing plate with the cam to acquire the better stabilization of the fence.

### BRIEF DESCRIPTION OF DRAWINGS

This invention will be better understood by referring to the accompanying drawings, wherein:

FIG. 1 is a cross-sectional view of a conventional fence in a table saw;

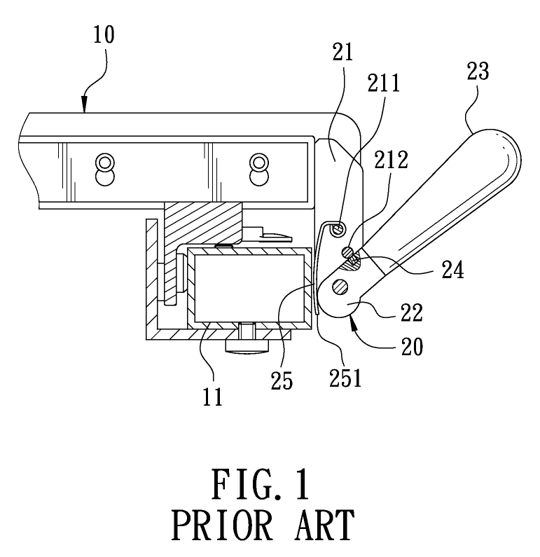

FIG. 2 is a side view of a preferred embodiment of a fence for a table saw in the present invention;

FIG. 3 is a partial perspective view of the preferred embodiment of a fence for a table saw in the present invention;

FIG. 4 is an exploded perspective view of a retention device in the present invention;

FIG. 5 is an exploded perspective view of an adjusting button in the present invention;

FIG. 6 is a side view of the retention device not tightened in the present invention;

FIG. 7 is a side view of the retention device tightened in the present invention; and,

FIG. 8 is a side view of the adjusting button to be adjusted in the present invention.

### DETAILED DESCRIPTION OF THE PREFERRED EMBODIMENT

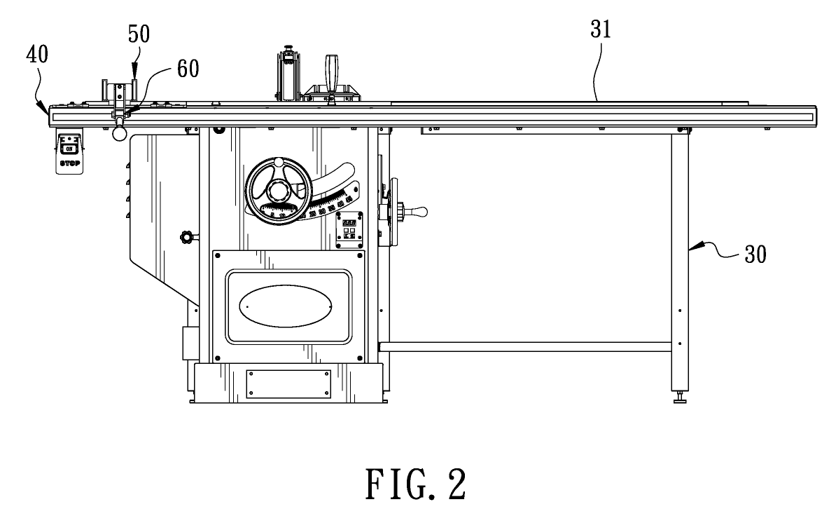

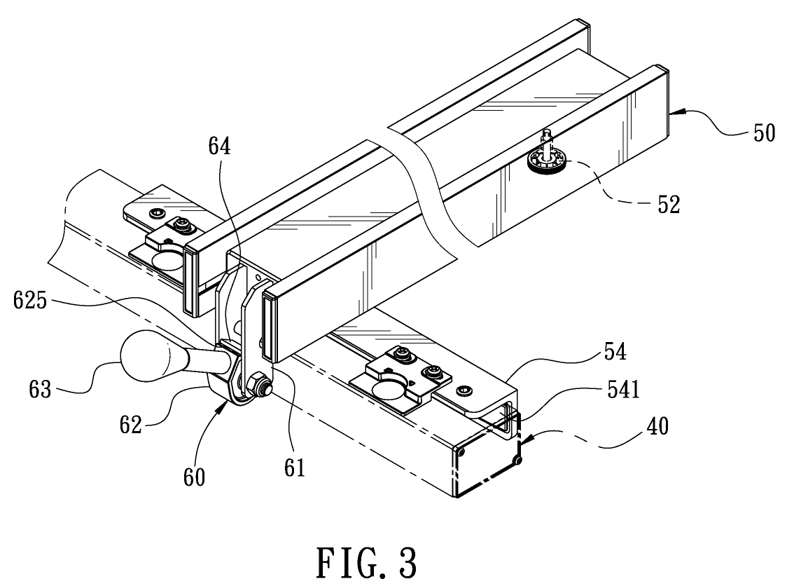

A preferred embodiment of a fence 50 for a table saw in the present invention, as shown in FIGS. 2 and 3, is installed on two rails 40 of a table saw, which also includes a base 30, and the fence 50 is provided with a retention device 60.

The base 30 is provided with a table 31 thereon.

The rails 40 are installed in parallel to each other at a front side and a rear side of the table 31 respectively, having a height flush with the table 31.

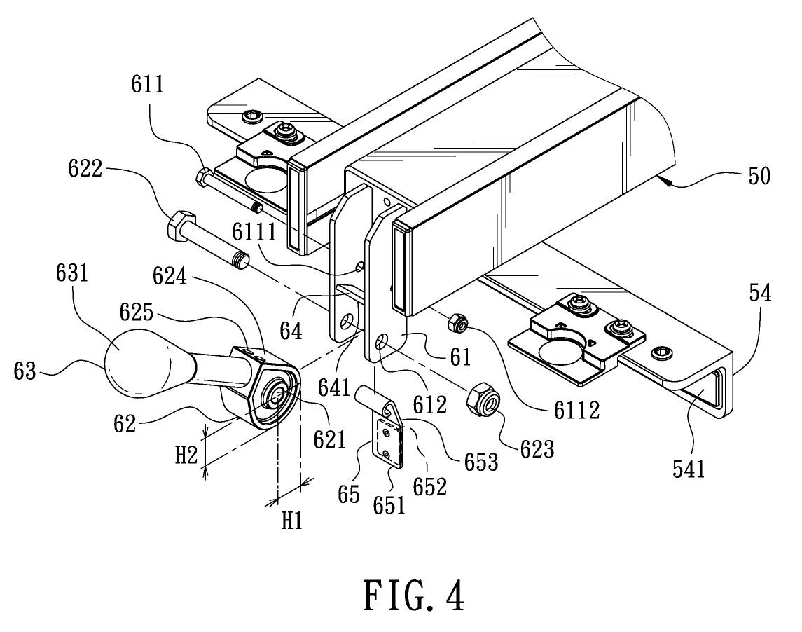

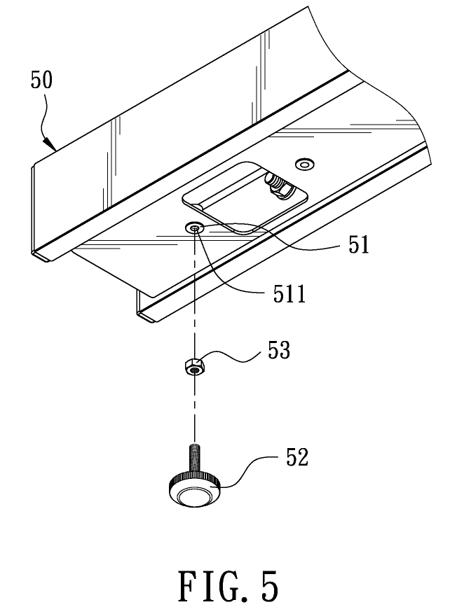

The fence 50 is deposited on the table 31, striding longitudinally on the two rails 40, as shown in FIGS. 4 and 5, provided with a round post 51 with a threaded hole 511 on the bottom of the rear end, an adjust button 52 made of wear-enduring plastic and engaging with the round post 51 and with a nut 53. In addition, the fence 50 has a retention plate 54 fixed at the front end, and a cushion sheet 541 of Teflon fixed on an inner side of the retention plate 54 and located between the rail 40 and the retention plate 54.

The retention device 60 is installed at the front end of the fence 50, composed of two fixing plates 61, a cam 62, a handle 63, a reinforcing plate 64 and a pressing plate 65.

The two fixing plates 61 are set vertically in parallel at a right side and a left side of the front end of the fence 50 respectively, having a fixing shaft 611 pivotally connected to the intermediate portion thereof, and a hole 6111 bored respectively for the fixing shaft 611 to pass through and then screw tightly with a nut 6112. The fixing plates 61 further respectively have a shaft hole 612 in a lower portion.

The cam 62 is pivotally connected to the lower portion of the two fixing plates 61, having a through hole 621 corresponding to the shaft hole 612 for a pivotal shaft 622 to pass through and further through the fixing plates 61 and then engage with a nut 623. Moreover, the cam 62 is provided with an attracting surface 624 on an upper end, with two magnetic elements 625 affixed thereon. Further, the cam 62 has a short radius (H1) near to the axis and a long radius (H2) farther from the axis.

The handle 63 is fixed to the cam 62 at its rear portion, having a grip 631 formed in a front portion for a user to easily hold.

The reinforcing plate 64 is flat, fixed inclinedly between the two fixing plates 6, and when the cam 62 is pivoted up, the attracting surface 624 will rest on a bottom surface 641 of the reinforcing plate 64.

The pressing plate 65 is pivotally connected to the fixing shaft 611, having a pressing section 651 formed in a lower portion and extending in a space between the rail 40 and the cam 40, with a pressing cushion 652 of Teflon affixed on the surface facing the rail 40. Further, a sloped section 653 is formed in the intermediate portion so that the pressing section 651 may contact with the cam in the bending direction of the sloped section 653.

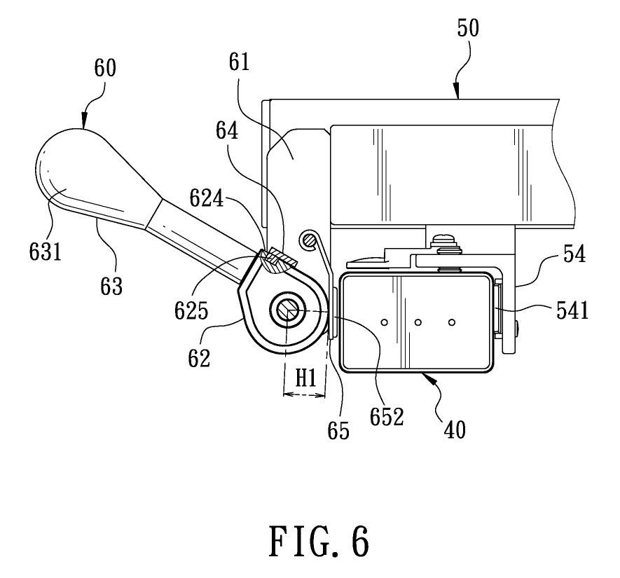

In using, as shown in FIG. 6, when a user holds the grip 631 of the handle 63 and lifts it up pivotally, the cam 62 is pivoted up eccentrically, permitting the attracting surface 624 move and contact in parallel with the bottom surface 641 of the reinforcing plate 64, with the magnetic elements 625 on the attracting surface 641 totally attracting and contacting with reinforcing plate 64 with its contacting are a effectively large and intensifying attracting force. At this time, the cam 62 contacts with the surface of the pressing plate 65 with its short radius (H1), forming a gap between the pressing cushion 652 and the rail 40. Then the retention device 60 is in a released condition relative to the rail 40, so the retention device 60 can slide freely by the handle 63 moving the fence 50 synchronously, for adjusting and selecting the position of the fence 50 on the rails 40 and the table 31.

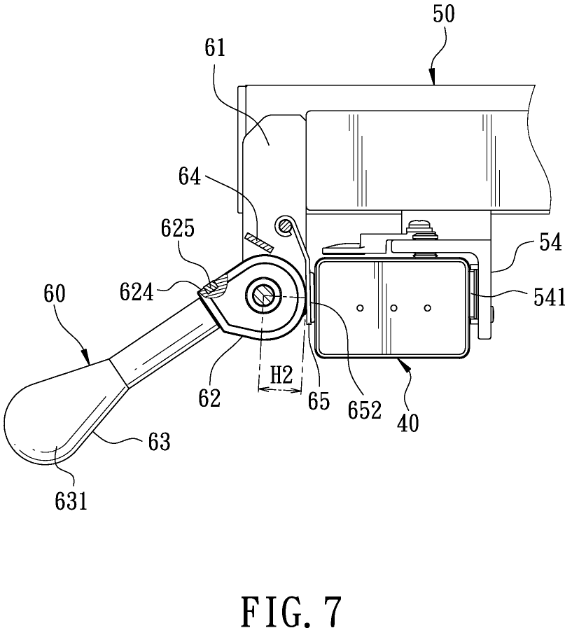

Next, when the handle 63 is pushed downward from the position shown in FIG. 6 to the position shown in FIG. 7, the cam 62 is pivoted down eccentrically by means of the pivotal shaft 622, and then presses the surface of the pressing plate 65 with its long radius (H2) to force the pressing plate 65 compress the rail 40, in conjunction with tightening function of the retention plate 64 to the rails 40. Then the retention device 60 is no longer able to slide freely, so fence 50 is fixedly secured at that position on the table 31 and the rails 40, permitting the user to use the table saw. It is to be noted that when the pressing cushion 652 is moved to push the rail 40, it can protect the surface of the rail 40 from damaged, and when the retention plate 54 presses on the rail 40, the cushion 541 also prevents the surface of the rails 40 from damaged.

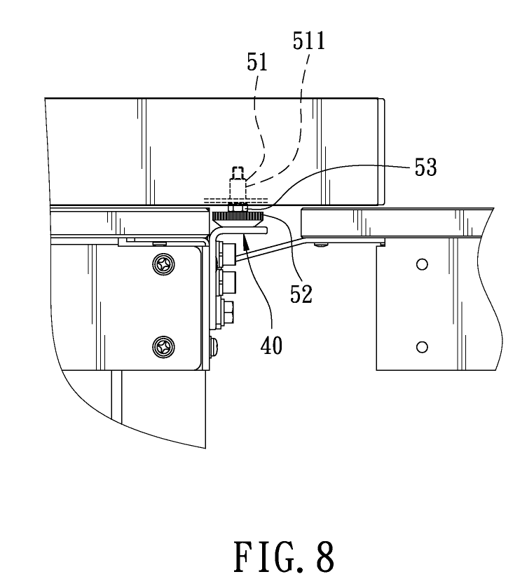

Next, referring to FIGS. 5 and 8, a user can use the adjusting button 52 that can be loosened for adjusting the level and vertical height of the fence 50, and tightened again after adjustment to keep the fence 50 in the immovable retained condition. In addition, the adjusting button 52 rests on the upper surface of the rail at the rear side of the table 31 so that the fence 50 has its bottom not directly touch the table 31, without possibility of frictional damage and thus having a long service life.

The invention has the following advantage, as can be understood from the foresaid description.

The reinforcing plate can strengthen the force of the fixing plates; when the handle is pivoted upward, it has a proper angle to let the magnetic elements attract and contact with the reinforcing plate with a comparatively large area, and thus greatly stabilizing the handle. Moreover, the adjusting button affixed to the fence enables a user to adjust the height of the fence for boosting convenience of using the table saw.

While the preferred embodiment of the invention has been described above, it will be recognized that various modifications may be made therein and the appended claims are intended to cover all such modifications that may fall within the spirit and scope of the invention.

What is claimed is:

1. A fence for a table saw, said table saw at least having a base, two rails and a table located on said base, said two rails installed in parallel at a front side and a rear side of said table respectively, said fence installed on said table and striding longitudinally on said two rails:
said fence provided with a retention device pivotally connected to one end of said fence, said retention device comprising;
two fixing plates installed vertically at a right side and a left side of an end of said fence respectively, a fixing shaft laterally passing through an intermediate portion of said fixing plates, said fixing plates respectively provided with a shaft hole in a lower portion to be aligned to each other;
a cam pivotally connected to a lower portion of said fixing plates, said cam having a through hole aligned to said shaft hole of said fixing plates for a shaft to pass through said fixing plates and said cam and then engage with a nut, said cam provided with an attracting surface on an upper side, two magnetic elements affixed on said attracting surface;
a handle having a lower end fixed with said cam and an upper end formed with a grip;
a reinforcing plate fixed inclinedly between said two fixing plates, said attracting surface of said cam contacting in parallel with a bottom surface of said reinforcing plate in case said cam is pivoted up;
a pressing plate having an upper end pivotally connected with said fixing shaft of said fixing plates, a pressing section formed in a lower portion of said pressing plate and extending in a space between said cam and said rail; and
said handle pushed up to force said cam to be pivoted up eccentrically with said shaft as a pivot so that said attracting surface of said cam moves and contacts with a bottom surface of said reinforcing plate, with said magnetic elements totally attracting and contacting with said reinforcing plate for increasing strength of mutual attraction.

2. The fence for a table saw as claimed in claim 1, wherein said pressing plate has its upper portion pivotally connected to said fixing shaft, and said pressing section has its lower end extending between said eccentric wheel and said slide rail, said pressing section further has a cushion of Teflon fixed on a side facing said rail so that said pressing cushion protects said rail from damaged when the pressing section contacts said slide rail, and said pressing plate has a sloped portion in an intermediate portion for resting on said cam.

3. The fence for a table saw as claimed in claim 1, wherein said fence is provided with a round post on a lower side facing said retention device, said round post has a threaded hole for an adjusting button to engage therein and with a nut.

4. The fence for a table saw as claimed in claim 3, wherein said adjusting button is made of wear-enduring plastic.

5. The fence for a table saw as claimed in claim 1, wherein said fence is provided with a retention plate at a side not facing said retention device, and said retention plate has a cushion of Teflon affixed on an inner side and located between said slide rail and said retention device so that said cushion protects said rail from damaged when said retention plate presses said rail.

6. The fence for a table saw as claimed in claim 1, wherein said magnetic elements are magnets.
